(19) United States
(12) Patent Application Publication
(10) Pub. No.: US 2020/0225873 A1
(43) Pub. Date: Jul. 16, 2020

(54) CONTROLLER, OPERATION METHOD OF CONTROLLER, AND MEMORY SYSTEM

(71) Applicant: SK hynix Inc., Gyeonggi-do (KR)

(72) Inventor: Eun-Jae OCK, Gyeonggi-do (KR)

(21) Appl. No.: 16/671,790

(22) Filed: Nov. 1, 2019

(30) Foreign Application Priority Data
Jan. 15, 2019 (KR) 10-2019-0004958

(51) Int. Cl. G06F 3/06; G06F 13/16; G06F 11/27

(52) U.S. Cl. CPC G06F 3/0659; G06F 3/061; G06F 11/27; G06F 13/1668; G06F 3/0679

(57) ABSTRACT

Provided is an operation method of a controller which controls a memory device including an operation parameter register. The operation method may include: receiving a write request from a host, the write request including a write command, a write address and write data; extracting from the write data a parameter change internal command for changing an operation parameter value of the memory device based on whether the write address is a specific address, the extracted parameter change internal command including an operation parameter address and operation parameter data; and setting an operation parameter of the memory device by controlling the memory device to store the operation parameter data in the operation parameter register corresponding to the operation parameter address, the operation parameter data corresponding to the operation parameter value.

### CROSS-REFERENCE TO RELATED APPLICATION

This application claims priority under 35 U.S.C. § 119 to Korean Patent Application No. 10-2019-0004958, filed on Jan. 15, 2019, which is incorporated herein by reference in its entirety.

### BACKGROUND

### 1. Field

Various embodiments relate to a controller for controlling a memory device and a memory system including the controller.

### 2. Discussion of the Related Art

The computer environment paradigm has been transitioning to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Since they have no moving parts, memory systems provide advantages such as excellent stability and durability, high information access speed, and low power consumption. Examples of memory systems having such advantages include universal serial bus (USB) memory devices, memory cards having various interfaces, and solid state drives (SSDs).

### SUMMARY

Various embodiments are directed to a controller capable of efficiently performing a test for the controller, and an operation method thereof.

In an embodiment, there is provided an operation method of a controller which controls a memory device including an operation parameter register. The operation method may include: receiving a write request from a host, the write request including a write command, a write address and write data; extracting from the write data a parameter change internal command for changing an operation parameter value of the memory device based on whether the write address is a specific address, the extracted parameter change internal command including an operation parameter address and operation parameter data; and setting an operation parameter of the memory device by controlling the memory device to store the operation parameter data in the operation parameter register corresponding to the operation parameter address, the operation parameter data corresponding to the operation parameter value.

In an embodiment, there is provided a controller which controls a memory device including an operation parameter register. The controller may include: a host interface suitable for receiving a request from a host, the request including a write command, a write address and write data; a command extractor suitable for extracting from the write data a parameter change internal command for changing an operation parameter value of the memory device based on whether the write address is a specific address, the extracted parameter change internal command including an operation parameter address and operation parameter data; and a memory interface suitable for setting an operation parameter of the memory device by controlling the memory device to store the operation parameter data in the operation parameter register corresponding to the operation parameter address, the operation parameter data corresponding to the operation parameter value.

In an embodiment, a memory system may include: a memory device including an operation parameter register; and a controller suitable for controlling the memory device. The controller may receive a host request including a write command, a write address and write data from a host, extract one or more parameter change internal commands for changing an operation parameter value of the memory device from the write data according to a result obtained by determining the host request by determining whether the write address is a predetermined address, and set an operation parameter of the memory device by controlling the memory device to store operation parameter data in the operation parameter register corresponding to an operation parameter address included in the extracted one or more parameter change internal commands, the operation parameter data corresponding to the operation parameter value included in the extracted one or more parameter change internal commands.

In an embodiment, a memory system may include: a memory device including a memory for storing an operation parameter; and a controller suitable for: receiving a write data; determining whether the write data includes parameter setting information; when it is determined that the write data includes parameter setting information, controlling the memory device to store the parameter setting information in the memory; and controlling the memory device to test whether an operation is performed based on the parameter setting information.

### BRIEF DESCRIPTION OF THE DRAWINGS

FIG. 1 schematically illustrates an example of a data processing system including a memory system in accordance with an embodiment.

FIG. 2 schematically illustrates an example of a memory device in the memory system in accordance with the present embodiment.

FIG. 3 schematically illustrates memory cell array circuits of memory blocks in the memory device in accordance with an embodiment.

FIG. 4 schematically illustrates a structure of the memory device in the memory system in accordance with an embodiment.

FIG. 5 illustrates a structure of a memory system including a controller in accordance with an embodiment.

FIGS. 6A and 6B illustrate an operation of the memory system including the controller in accordance with an embodiment.

FIG. 7 illustrates write data according to bit order, in accordance with an embodiment.

FIGS. 8 to 16 schematically illustrate other examples of the data processing system including the memory system in accordance with various embodiments.

### DETAILED DESCRIPTION

Various embodiments of the present invention are described in detail below with reference to the accompanying drawings. It should be understood that the following description focuses features and aspects for understanding the present invention, while description of known technical matter may be omitted so as not to unnecessarily obscure subject matter of the present invention.

Throughout the specification, reference to “an embodiment,” “another embodiment” or the like is not necessarily to only one embodiment, and different references to any such phrase are not necessarily to the same embodiment(s).

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

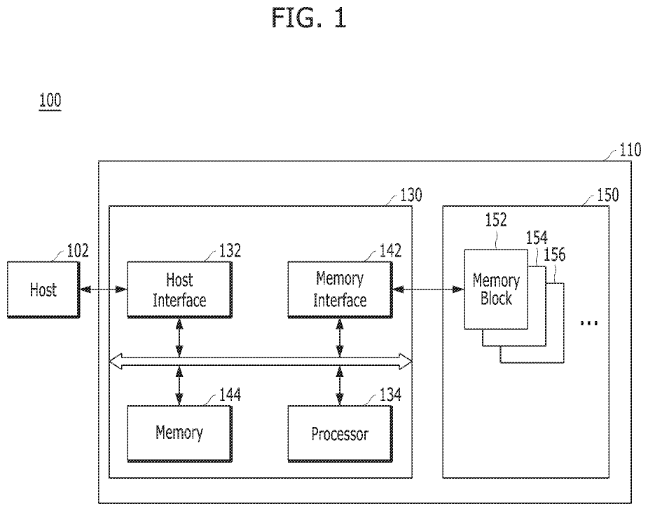

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include any of various portable electronic devices such as a mobile phone, MP3 player and laptop computer, or any of various non-portable electronic devices such as a desktop computer, a game machine, a television (TV), and a projector.

The host 102 may include at least one operating system (OS), which may manage and control overall functions and operations of the host 102, and provide operation between the host 102 and a user of the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user.

For example, the personal OS configured to support a function of providing a service to general users may include Windows and Chrome, and the enterprise OS configured to secure and support high performance may include Windows server, Linux and Unix. Furthermore, the mobile OS configured to support a function of providing a mobile service to users and a power saving function of a system may include Android, iOS and Windows Mobile. The host 102 may include a plurality of OSs, one or more of which is executed to perform an operation corresponding to a user's request on the memory system 110.

The memory system 110 may operate to store data for the host 102 in response to a request of the host 102. Non-limiting examples of the memory system 110 include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and/or the like. The SD card may include a mini-SD card and/or micro-SD card.

The memory system 110 may be embodied by any of various types of storage devices. Examples of such storage devices include, but are not limited to, volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory.

The memory system 110 may include a controller 130 and a memory device 150.

The controller 130 and the memory device 150 may be integrated into a single semiconductor device. For example, the controller 130 and the memory device 150 may be integrated as one semiconductor device to constitute a solid state drive (SSD). When the memory system 110 is used as an SSD, the operating speed of the host 102 connected to the memory system 110 can be improved. Alternatively, the controller 130 and the memory device 150 may be integrated as one semiconductor device to constitute a memory card, such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD card, micro-SD card and SDHC card, or universal flash storage (UFS) device.

Non-limiting application examples of the memory system 110 include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device that retains data stored therein even when power is not supplied. The memory device 150 may store data provided from the host 102 through a write operation, and provide data stored therein to the host 102 through a read operation. The memory device 150 may include a plurality of memory blocks including memory blocks 152, 154, and 156. Each of the memory blocks may include a plurality of pages. Each of the pages may include a plurality of memory cells coupled to a word line. In an embodiment, the memory device 150 may be a flash memory. The flash memory may have a 3-dimensional (3D) stack structure.

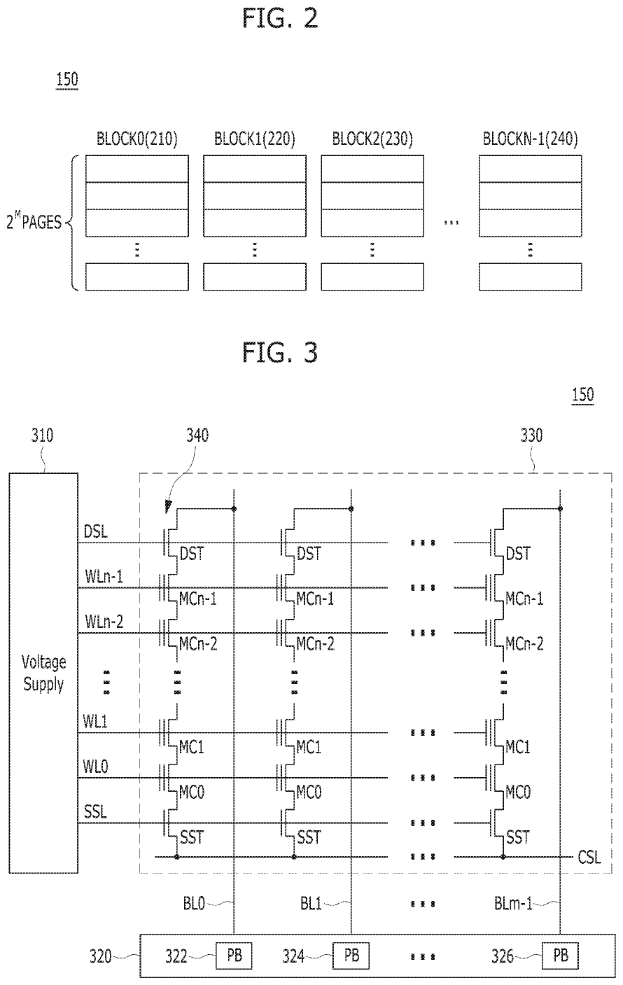

The structure of the memory device 150 including its 3D stack structure is described in detail below with reference to FIGS. 2 to 4.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, program and erase operations of the memory device 150.

The controller 130 may include a host interface 132, a processor 134, a memory interface 142 such as a NAND flash controller (NFC), and a memory 144, all operatively coupled via an internal bus.

The host interface 132 may be configured to process a command and data of the host 102. The host interface 132 may communicate with the host 102 through one or more of various interface protocols, such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and/or integrated drive electronics (IDE). The host interface 132 may be driven through firmware referred to as a host interface layer (HIL) in order to exchange data with the host.

The memory interface 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory interface 142 may generate a control signal for the memory device 150 and process data to be provided to the memory device 150 under the control of the processor 134. The memory interface 142 may work as an interface (e.g., a NAND flash interface) for processing a command and data between the controller 130 and the memory device 150. Specifically, the memory interface 142 may support data transfer between the controller 130 and the memory device 150. The memory interface 142 may be driven through firmware referred to as a flash interface layer (FIL) in order to exchange data with the memory device 150.

The memory interface 142 may include an ECC component. The ECC component may detect and correct an error contained in the data read from the memory device 150. In other words, the ECC component may perform an error correction decoding process to the data read from the memory device 150 through an ECC value used during an ECC encoding process. According to a result of the error correction decoding process, the ECC component may output a signal, for example, an error correction success/fail signal. When the number of error bits is more than a threshold value of correctable error bits, the ECC component may not correct the error bits, and may output an error correction fail signal.

The ECC component may perform error correction through a coded modulation, such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and/or Block coded modulation (BCM). However, the ECC component is not limited to any specific error correction technique or structure. The ECC component may include any and all circuits, modules, systems or devices for suitable error correction.

The memory 144 may serve as a working memory of the memory system 110 and the controller 130. The memory 144 may store data for driving the memory system 110 and the controller 130. The controller 130 may control the memory device 150 to perform read, program and erase operations in response to a request from the host 102. The controller 130 may provide data read from the memory device 150 to the host 102. The controller 130 may store data provided from the host 102 into the memory device 150. The memory 144 may store data required for the controller 130 and the memory device 150 to perform these operations.

The memory 144 may be embodied by a volatile memory. For example, the memory 144 may be embodied by a static random access memory (SRAM) or dynamic random access memory (DRAM). The memory 144 may be disposed within or externally to the controller 130. FIG. 1 exemplifies the memory 144 disposed within the controller 130. In an embodiment, the memory 144 may be embodied by an external volatile memory having a memory interface transferring data between the memory 144 and the controller 130.

As described above, the memory 144 may store data required for performing a data write/read operation between the host 102 and the memory device 150 and data when the data write/read operation is performed. In order to store such data, the memory 144 may include a program memory, data memory, write buffer/cache, read buffer/cache, data buffer/cache, map buffer/cache or the like.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor and/or a central processing unit (CPU).

For example, the controller 130 may perform an operation requested by the host 102 through the processor 134. In other words, the controller 130 may perform a command operation corresponding to a command received from the host 102. The controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command or a set feature command.

The controller 130 may perform a background operation onto the memory device 150 through the processor 134. The background operation may include copying and processing data stored in some memory blocks among the memory blocks 152 to 156 of the memory device 150 into other memory blocks, e.g., a garbage collection (GC) operation, swapping data among multiple memory blocks of the memory blocks 152 to 156, e.g., a wear-leveling (WL) operation, storing the map data stored in the controller 130 in at least some of the memory blocks 152 to 156, e.g., a map flush operation, and/or managing bad blocks of the memory device 150, e.g., detecting and processing bad blocks among the memory blocks 152 to 156.

A memory device of the memory system in accordance with an embodiment of the present invention is described in detail with reference to FIGS. 2 to 4.

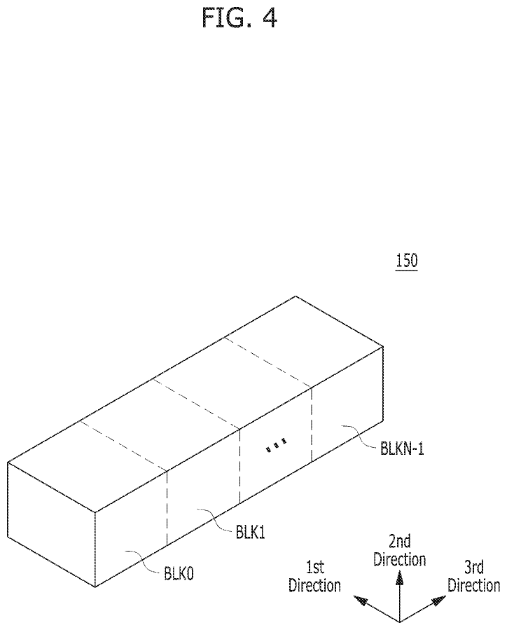

FIG. 2 is a schematic diagram illustrating the memory device 150. FIG. 3 is a diagram illustrating a memory cell array of a memory block in the memory device 150. FIG. 4 is a diagram illustrating a three-dimensional (3D) structure of the memory device 150.

Referring to FIG. 2, the memory device 150 may include a plurality of memory blocks, e.g., BLOCK0 (210), BLOCK1 (220), BLOCK2 (230), . . . BLOCKN-1 (240). Each of the memory blocks 210, 220, 230 and 240 may include a plurality of pages, for example 2^{M} pages, the number of which may vary according to circuit design. For example, in some applications, each of the memory blocks may include M pages. Each of the pages may include a plurality of memory cells that are coupled to a word line WL.

The memory device 150 may include a plurality of memory blocks, which may include a single level cell (SLC) memory block having SLC memory cells each storing 1-bit data and/or a multi-level cell (MLC) memory block having MLC memory cells each storing multi-bit data. The SLC memory blocks may include a plurality of pages that are realized by SLCs. The SLC memory blocks may have fast data operation performance and high durability. On the other hand, the MLC memory blocks may include a plurality of pages that are realized by MLCs. The MLC memory blocks may have a greater data storing space than the SLC memory blocks. In other words, the MLC memory blocks may be highly integrated.

In accordance with an embodiment of the present invention, the memory device 150 is described as a non-volatile memory, such as a flash memory, e.g., a NAND flash memory. However, the memory device 150 may be realized as any of a Phase Change Random Access Memory (PCRAM), a Resistive Random Access Memory (RRAM or ReRAM), a Ferroelectric Random Access Memory (FRAM), a Spin Transfer Torque Magnetic Random Access Memory (STT-RAM or STT-MRAM).

The memory blocks 210, 220, 230, . . . 240 may store the data transferred from the host 102 through a program operation, and transfer data stored therein to the host 102 through a read operation.

FIG. 3 shows a memory block 330, which is representative of any of the plurality of memory blocks 152 to 156 included in the memory device 150 of the memory system 110. Memory block 330 may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST and SST, a plurality of memory cells or memory cell transistors MC0 to MCn-1 may be coupled in series. In an embodiment, each of the memory cells MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1. For reference, in FIG. 3, ‘DSL’ denotes a drain select line, ‘SSL’ denotes a source select line, and ‘CSL’ denotes a common source line.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure that includes a plurality of memory blocks BLK0 to BLKN-1.

Each memory block 330 in the memory device 150 may include a plurality of NAND strings NS that extend in the second direction, and a plurality of NAND strings NS (not shown) that extend in the first direction and the third direction. Each of the NAND strings NS may be coupled to a bit line BL, at least one drain selection line DSL, at least one source selection line SSL, a plurality of word lines WL, at least one dummy word line DWL (not shown), and a common source line CSL. Each of the NAND strings NS may include a plurality of transistor structures.

In short, each memory block 330 of the memory device 150 may be coupled to a plurality of bit lines BL, a plurality of drain selection lines DSL, a plurality of source selection lines SSL, a plurality of word lines WL, a plurality of dummy word lines DWL, and a plurality of common source lines CSL. Each memory block 330 may include a plurality of NAND strings NS. In each memory block 330, one bit line BL may be coupled to a plurality of NAND strings NS to realize a plurality of transistors in one NAND string NS. A drain selection transistor DST of each NAND string NS may be coupled to a corresponding bit line BL, and a source selection transistor SST of each NAND string NS may be coupled to a common source line CSL. Memory cells MC may be provided between the drain selection transistor DST and the source selection transistor SST of each NAND string NS. In other words, a plurality of memory cells may be realized in each memory block 330 of the memory device 150.

The operation of the memory device 150 may be determined by various operation parameters. For example, when a write operation is performed, a program voltage applied to a word line may be determined according to a start voltage parameter and a step voltage parameter. The number of times that the program voltage is applied to the word line may be determined according to a voltage application count parameter.

The host 102 may frequently change various operation parameters of the memory system 110. For example, the host 102 may change the operation parameters to test an operation of the controller 130.

The host 102 may change the operation parameters to construct an operation environment similar to a high-temperature/low-temperature operation or a long-term operation of the memory device 150. For example, the host 102 may adjust the start voltage parameter, the step voltage parameter and/or the voltage application count parameter of the memory device 150. After adjusting the parameter(s), the host 102 may intentionally reduce the reliability of data to be stored in the memory device 150.

Conventionally, the host 102 may provide a vendor command to the controller 130 in order to change one or more of the operation parameters. The controller 130 may provide an internal command to the memory device 150 in response to the vendor command. The vendor command may indicate a command which can be defined by a provider of the controller 130 and used in the controller 130. The memory device 150 may set an operation parameter by changing data of a region corresponding to an operation parameter to be changed in an internal operation parameter register in response to the internal command.

The host 102 may provide a write command to the controller 130 in order to test an operation of the controller 130 for controlling the memory device 150 which operates based on the changed operation parameter. The controller 130 may provide the write command to the memory device 150. The host 102 may provide a read command to the controller 130 to read data written in response to the write command. The controller 130 may provide the read command to the memory device 150. For example, the controller 130 may correct an error of the data read from the memory device 150, and thus provide the corrected data to the host 102. The host 102 may determine whether the controller 130 normally operates even in an operation environment where the reliability of the memory device 150 is degraded, based on the corrected data.

In accordance with an embodiment, when receiving a host request including a write command for a particular address and write data from the host 102, the controller 130 may parse the write data to extract one or more parameter change internal commands. The controller 130 may provide the extracted parameter change internal command(s) to the memory device 150, and control the memory device 150 to set an operation parameter based on the extracted parameter change internal command(s). Therefore, the host 102 may provide one write command in order to control the memory device 150 to set one or more operation parameters.

In an embodiment, the controller 130 may control the memory device 150 to write the write data to the memory device 150 in response to the write command. That is, the memory device 150 may not only set the operation parameter but also write the write data, in response to the write command that satisfies a set condition, which may be predetermined. The write data may be written to the memory device 150 as dummy data for testing the operation of the controller 130.

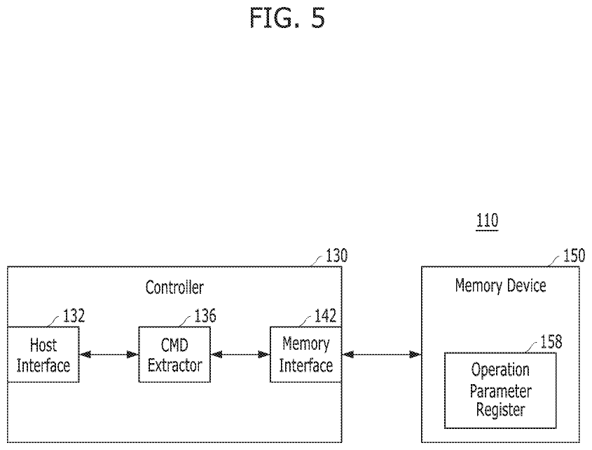

FIG. 5 illustrates the structure of the memory system 110 including the controller 130 in accordance with an embodiment.

Referring to FIG. 5, the controller 130 may include a host interface 132, a command (CMD) extractor 136 and a memory interface 142. The memory device 150 may include the plurality of memory blocks (not illustrated), which have been described with reference to FIGS. 1 to 4, and an operation parameter register 158. The host interface 132 and the memory interface 142 may correspond to the host interface 132 and the memory interface 142 of FIG. 1, respectively.

In accordance with an embodiment, when a host request includes a write command and a specific address, which may be predetermined, the command extractor 136 may parse write data included in the host request, and extract one or more parameter change internal commands from the write data.

In an implementation, the command extractor 136 may be loaded to the memory 144 of FIG. 1, and driven by the processor 134. In an implementation, the command extractor 136 may be implemented as a field programmable gate array (FPGA).

The operation parameter register 158 may store various operation parameters. The various operation parameters may be grouped according to parameter attributes such as a write operation parameter, a read operation parameter and an erase operation parameter. The grouped operation parameters may be separately stored in respective different regions of the operation parameter register 158. The memory device 150 may perform a read operation, a write operation and an erase operation based on the parameter values set in the operation parameter register 158.

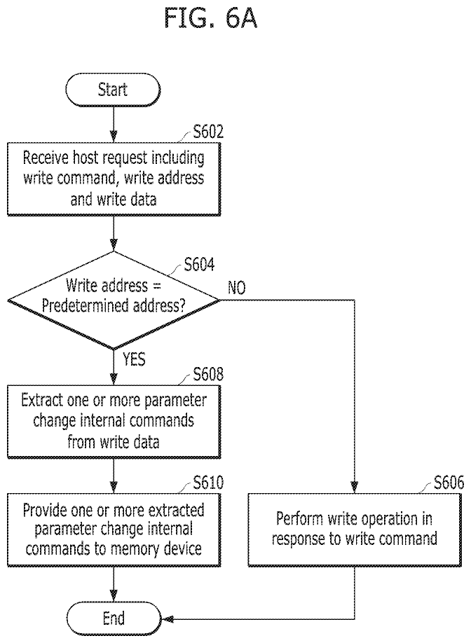

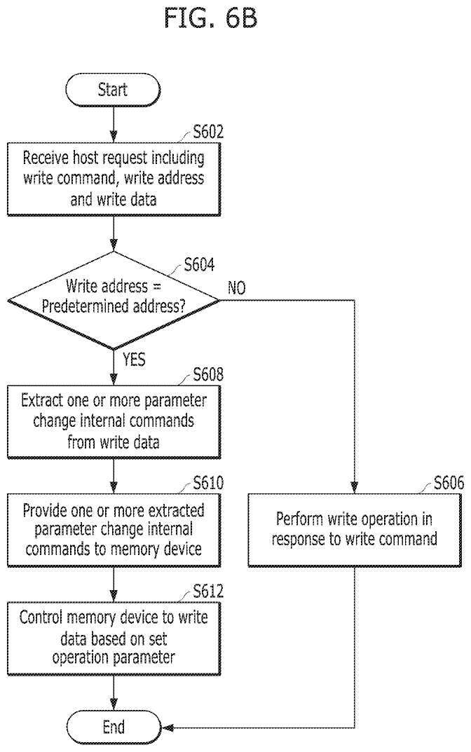

FIG. 6A illustrates an operation of the memory system 110 including the controller 130 in accordance with an embodiment.

Referring to FIG. 6A, in step S602, the host interface 132 may receive a host request from the host 102. The host request may include a write command, a write address and write data.

In step S604, the command extractor 136 may determine whether the write address is a specific, e.g., predetermined, address.

When it is determined that the write address is not the specific address (“NO” in step S604), the command extractor 136 may provide the write command, the write address and the write data to the memory device 150 through the memory interface 142. The memory device 150 may write the write data to a memory region indicated by the write address in response to the write command.

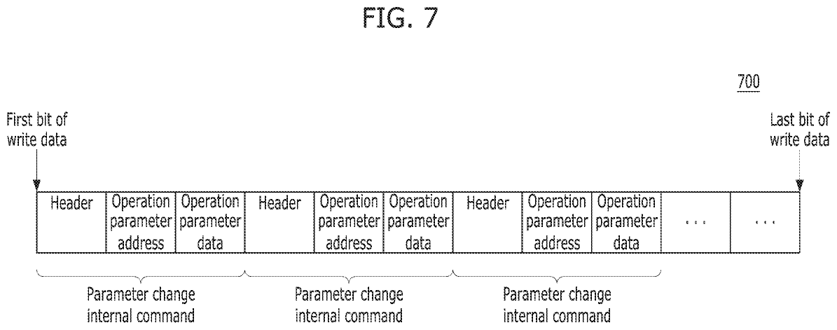

When it is determined that the write address is the specific address (“YES” in step S604), the command extractor 136 may extract one or more parameter change internal commands from the write data, in step S608. The parameter change internal command(s) may be extracted from the write data by parsing the write data according to a protocol common to the host 102. Examples of the protocol are described below with reference to FIG. 7.

In step S610, the memory interface 142 may provide the extracted parameter change internal command(s) to the memory device 150. The memory device 150 may set an operation parameter by changing data of the operation parameter register 158 in response to the parameter change internal command(s).

FIG. 6B illustrates an operation of the memory system 110 including the controller 130 in accordance with an embodiment.

Steps S602 to S610 of FIG. 6B may correspond to steps S602 to S610 of FIG. 6A.

Referring to FIG. 6B, in step S612, the memory interface 142 may control the memory device 150 to write the write data to a memory region corresponding to the specific address in response to the write command in the host request. The memory device 150 may write the write data based on the set operation parameter. When the write data including the parameter change internal command(s) is written to the memory device 150, the write data may be used as dummy data for testing the operation of the controller 130. Further, the host 102 may provide the controller 130 with a host request including a read command and the specific address, in order to test the operation of the controller 130.

FIG. 7 illustrates write data 700 in accordance with an embodiment. The leftmost item of the write data 700 may indicate the first bit of the write data, and the rightmost item of the write data 700 may indicate the last bit of the write data. When a host request includes a write command for a specific address, the command extractor 136 may sequentially parse the write data from the first bit to the last bit.

The write data may include one or more parameter change internal commands depending on a protocol, which is shared by the host 102 and the command extractor 136.

In an embodiment, the protocol may define data in each of the parameter change internal commands.

Each of the parameter change internal commands may include a header, an operation parameter address and operation parameter data. The operation parameter address and the operation parameter data may have fixed or predetermined lengths, respectively. The operation parameter address and the operation parameter data may sequentially follow the header.

The header may indicate that the operation parameter data following the header is a parameter change internal command. The operation parameter address may indicate a region where an operation parameter to be set among a plurality of operation parameters is stored in the operation parameter register 158. The operation parameter address may include position information on an operation parameter group depending on parameter attributes, such as a write operation parameter, a read operation parameter and an erase operation parameter, and individual operation parameters in the corresponding operation parameter group. The operation parameter data may indicate a parameter value which is to be set in the operation parameter to be set.

The host 102 may provide write data to the controller 130. In some embodiments, the write data may include one or more parameter change internal commands, each including a header, an operation parameter address and operation parameter data. The command extractor 136 may detect the one or more headers by parsing the write data, and extract data following each of the one or more headers as the parameter change internal command. The command extractor 136 may further extract the operation parameter data, the operation parameter group and the position information of the operation parameter from the parameter change internal command.

In an embodiment, the protocol may define in which bit of the bits of the write command the parameter change internal command is included. FIG. 7 illustrates the case in which multiple parameter change internal commands are consecutive from the first bit of the write data, as an example of the protocol.

The host 102 may provide the controller 130 with a write command including one or more parameter change internal commands. The command extractor 136 may detect a header in a bit corresponding to a set order by parsing write data according to that order. Further, the command extractor 136 may extract data following the one or more headers as a parameter change internal command. The command extractor 136 may repeat the operation of detecting the header and extracting the parameter change internal command, until there is no header in a bit corresponding to the next order.

In accordance with an embodiment, the host 102 may provide a write command for a specific address without providing a separate vendor command which can be implemented differently for the controller 130, thereby setting an operation parameter of the memory device 150. The write data provided as one host request by the host 102 may include a plurality of parameter change internal commands. Therefore, the host 102 may set a plurality of operation parameters through one request.

In accordance with an embodiment, when the host 102 provides a host request including a write command, a write address and write data, the memory device 150 may not only change one or more operation parameters in response to the write data received with the write command, but also write the write data to a specific address. Then, the host 102 may provide a read command for the specific address to test the operation of the controller 130 based on the data read from the memory device 150. That is, the host 102 may complete a write operation for changing an operation parameter and testing the operation of the controller 130, through one write command.

The host 102 may test the operation of the memory system 110 while changing various types of operation parameters. In accordance with an embodiment, the host 102 may provide one write command to change various types of operation parameters. When the test is completed, the host 102 may provide one write command to return the changed operation parameters to the original parameter values.

The case in which the host 102 tests the operation of the memory system 110 while changing an operation parameter is only an example of a case in which an operation parameter is changed. In another embodiment, the host 102 changes an operation parameter.

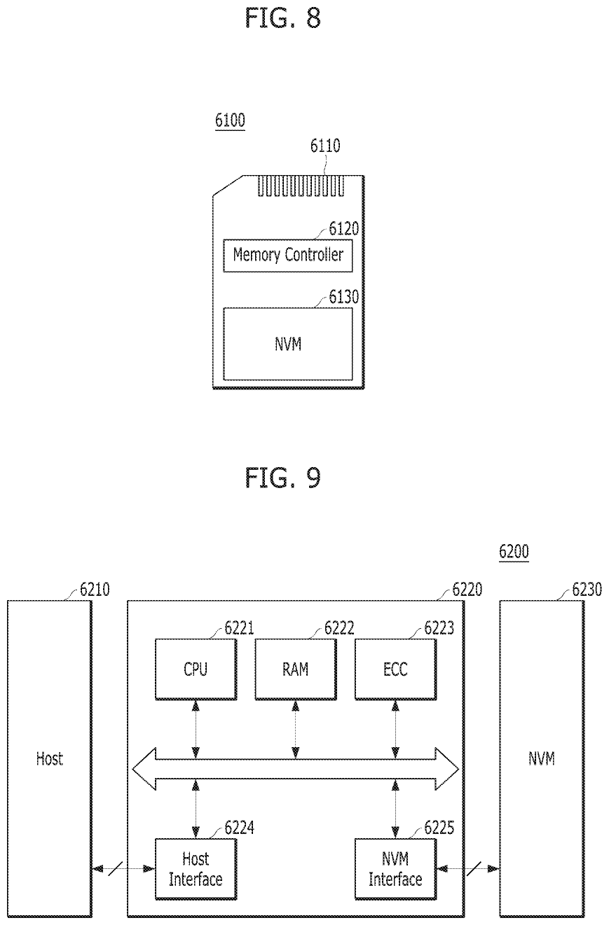

Referring to FIGS. 8 to 16, data processing systems and electronic devices to which the above-described memory system 110, including the memory device 150 and the controller 130, may be applied are described in more detail.

FIG. 8 is a diagram schematically illustrating the data processing system including the memory system in accordance with an embodiment. For example, FIG. 8 schematically illustrates a memory card system 6100 to which the memory system in accordance with an embodiment is applied.

Referring to FIG. 8, the memory card system 6100 may include a memory controller 6120, a memory device 6130 and a connector 6110.

More specifically, the memory controller 6120 may be connected to the memory device 6130 embodied by a nonvolatile memory (NVM), and configured to access the memory device 6130. For example, the memory controller 6120 may be configured to control read, write, erase and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, as shown in FIG. 1, the memory controller 6120 may include a random access memory (RAM), a processor, a host interface, a memory interface and an error correction component.

The memory controller 6120 may communicate with an external device, for example the host 102 of FIG. 1, through the connector 6110. For example, as described with reference to FIG. 1, the memory controller 6120 may be configured to communicate with an external device through one or more of various communication protocols, such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and/or Bluetooth. Thus, the memory system and the data processing system in accordance with an embodiment may be applied to wired and/or wireless electronic devices, particularly mobile electronic devices.

The memory device 6130 may be implemented by a nonvolatile memory. For example, the memory device 6130 may be implemented by any of various nonvolatile memory devices, such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and/or a spin torque transfer magnetic RAM (STT-RAM).

The memory controller 6120 and the memory device 6130 may be integrated into a single semiconductor device. For example, the memory controller 6120 and the memory device 6130 may be integrated to form a solid-state driver (SSD). Also, the memory controller 6120 and the memory device 6130 may form a memory card, such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an secured digital (SD) card (e.g., miniSD card, microSD card and SDHC card) and/or a universal flash storage (UFS).

FIG. 9 is a diagram schematically illustrating another example of a data processing system 6200 including the memory system in accordance with an embodiment.

Referring to FIG. 9, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF card, SD card or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component of the controller 130 illustrated in FIG. 1.

The memory controller 6220 may exchange data with the host 6210 through the host interface 6224, and exchange data with the memory device 6230 through the NVM interface 6225. The host interface 6224 may be connected to the host 6210 through a parallel advanced technology attachment (PATA) bus, serial advanced technology attachment (SATA) bus, small computer system interface (SCSI), universal serial bus (USB), peripheral component interconnect-express (PCIe) or NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then exchange data with the external device. In particular, as the memory controller 6220 is configured to communicate with the external device through one or more of various communication protocols, the memory system and the data processing system may be applied to wired and/or wireless electronic devices, particularly a mobile electronic device.

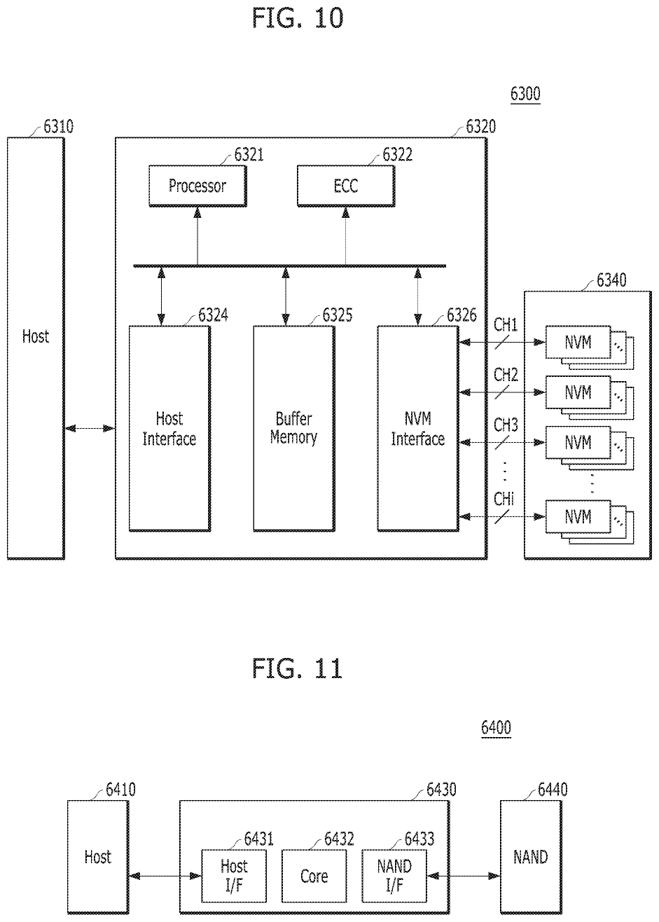

FIG. 10 is a diagram schematically illustrating another example of the data processing system including the memory system in accordance with an embodiment. FIG. 10 schematically illustrates a solid state drive (SSD) 6300 to which the memory system may be applied.

Referring to FIG. 10, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as dynamic random access memory (DRAM), synchronous DRAM (SDRAM), double data rate (DDR) SDRAM, low power DDR (LPDDR) SDRAM and graphics RAM (GRAM) or nonvolatile memories such as ferroelectric RAM (FRAM), resistive RAM (RRAM or ReRAM), spin-transfer torque magnetic RAM (STT-MRAM) and phase-change RAM (PRAM). By way of example, FIG. 10 illustrates that the buffer memory 6325 is disposed in the controller 6320. However, the buffer memory 6325 may be disposed externally to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system in accordance with an embodiment. For example, FIG. 11 schematically illustrates an embedded Multi-Media Card (eMMC) 6400 to which the memory system may be applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

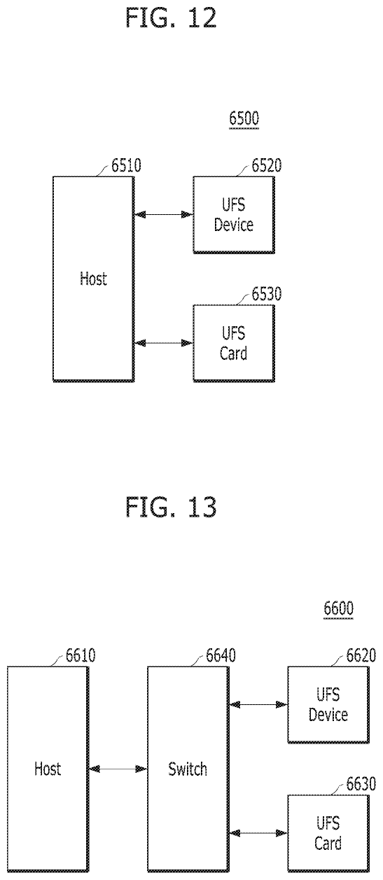

FIGS. 12 to 15 are diagrams schematically illustrating other examples of the data processing system including the memory system in accordance with one or more embodiments. FIGS. 12 to 15 schematically illustrate universal flash storage (UFS) systems to which the memory system may be applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired and/or wireless electronic devices or particularly mobile electronic devices, the UFS devices 6520, 6620, 6720 and 6820 may serve as embedded UFS devices. The UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices or particularly mobile electronic devices through UFS protocols. The UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, universal storage bus (USB) Flash Drives (UFDs), multi-media card (MMC), secure digital (SD), mini-SD, and micro-SD.

In the UFS system 6500 illustrated in FIG. 12, each of the host 6510, the UFS device 6520 and the UFS card 6530 may include UniPro.

The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the embodiment of FIG. 12, the configuration in which one UFS device 6520 and one UFS card 6530 are connected to the host 6510 is illustrated by way of example. However, in another embodiment, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the embodiment of FIG. 13, the configuration in which one UFS device 6620 and one UFS card 6630 are connected to the switching module 6640 is illustrated by way of example. However, in another embodiment, a plurality of UFS devices and UFS cards may be connected in parallel or in the form of a star to the switching module 6640, and a plurality of UFS cards may be connected in series or in the form of a chain to the UFS device 6620.

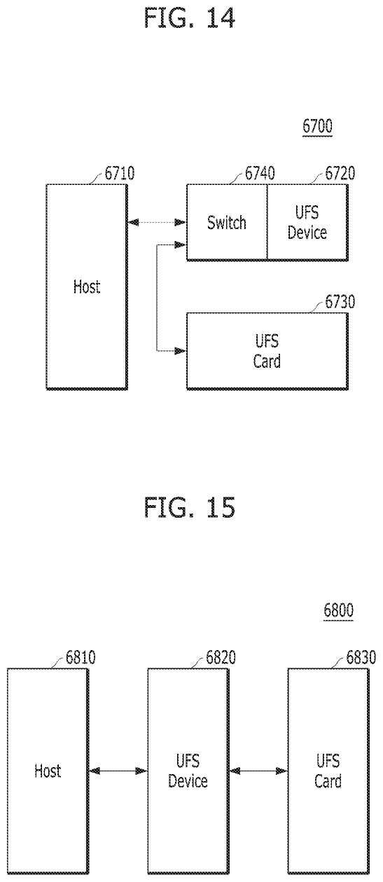

In the UFS system 6700 illustrated in FIG. 14, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the embodiment of FIG. 14, the configuration in which one UFS device 6720 and one UFS card 6730 are connected to the switching module 6740 is illustrated by way of example. However, in another embodiment, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In the embodiment of FIG. 15, the configuration in which one UFS device 6820 is connected to the host 6810 and one UFS card 6830 is connected to the UFS device 6820 is illustrated by way of example. However, in another embodiment, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

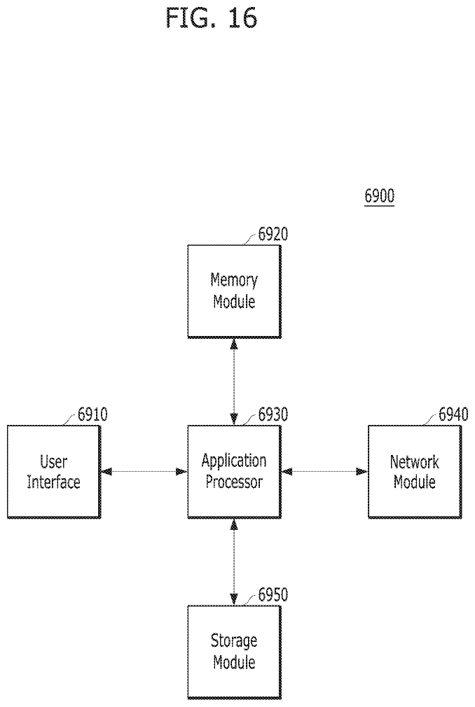

FIG. 16 is a diagram schematically illustrating another example of the data processing system including the memory system in accordance with an embodiment. FIG. 16 is a diagram schematically illustrating a user system 6900 to which the memory system may be applied.

Referring to FIG. 16, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR2 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the application processor 6930 on a display/touch module of the mobile electronic device, or support a function of receiving data from the touch panel.

In accordance with various embodiments, it is possible to provide a controller capable of efficiently performing a test for the controller, and an operation method thereof.

Although various embodiments have been illustrated and described, it will be apparent to those skilled in the art in light of the present disclosure that various changes and modifications may be made without departing from the spirit and scope of the invention as defined in the following claims.

What is claimed is:

1. An operation method of a controller which controls a memory device including an operation parameter register, the operation method comprising:
receiving a write request from a host, the write request including a write command, a write address and write data;
extracting from the write data a parameter change internal command for changing an operation parameter value of the memory device based on whether the write address is a specific address, the extracted parameter change internal command including an operation parameter address and operation parameter data; and
setting an operation parameter of the memory device by controlling the memory device to store the operation parameter data in the operation parameter register corresponding to the operation parameter address, the operation parameter data corresponding to the operation parameter value.

2. The operation method of claim 1, further comprising controlling the memory device to write the write data to a memory region corresponding to the write address.

3. The operation method of claim 2, further comprising:
receiving a read request from the host, the read request including a read command and the specific address; and
controlling the memory device to read the write data in response to the read command.

4. The operation method of claim 1, wherein the extracting of the parameter change internal command from the write data comprises:
detecting a header from the write data; and
extracting data following the header as the parameter change internal command.

5. The operation method of claim 1, further comprising controlling the memory device to execute the write request when it is determined that the write address is not the specific address.

6. A controller which controls a memory device including an operation parameter register, the controller comprising:
a host interface suitable for receiving a write request from a host, the write request including a write command, a write address and write data;
a command extractor suitable for extracting from the write data a parameter change internal command for changing an operation parameter value of the memory device based on whether the write address is a specific address, the extracted parameter change internal command including an operation parameter address and operation parameter data; and
a memory interface suitable for setting an operation parameter of the memory device by controlling the memory device to store the operation parameter data in the operation parameter register corresponding to the operation parameter address, the operation parameter data corresponding to the operation parameter value.

7. The controller of claim 6, wherein the memory interface controls the memory device to write the write data to a memory region corresponding to the write address.

8. The controller of claim 7, wherein the host interface receives a read request from the host, the read request including a read command and the specific address, and
the memory interface controls the memory device to read the write data in response to the read command.

9. The controller of claim 6, wherein the command extractor extracts a header, the operation parameter data, and the operation parameter address of the extracted parameter change internal command.

10. The controller of claim 9, wherein the command extractor further extracts, from the operation parameter address, an operation parameter group depending on an attribute of an operation parameter to be changed and position information of the operation parameter to be changed within the operation parameter group.

11. The controller of claim 9, wherein the command extractor detects a header from the write data, and extracts data following the header as the parameter change internal command.

12. The controller of claim 6, wherein the host interface receives the write data including the parameter change internal command.

13. The controller of claim 12, wherein the command extractor parses the write data according to a bit order.

14. The controller of claim 13, wherein the memory interface controls the memory device to execute the write request when it is determined that the write address is not the specific address.

15. A memory system comprising:
a memory device including a memory for storing an operation parameter; and
a controller suitable for:
receiving a write data;
determining whether the write data includes parameter setting information;
when it is determined that the write data includes parameter setting information, controlling the memory device to store the parameter setting information in the memory; and
controlling the memory device to test whether an operation is performed based on the parameter setting information.
